(19) United States
(12) Patent Application Publication
(10) Pub. No.: US 2016/0005088 A1
(43) Pub. Date: Jan. 7, 2016

(54) SYSTEMS AND METHODS FOR GIVING AND RECEIVING CHARITABLE DONATIONS

(71) Applicant: William Robert Parkinson, Santa Monica, CA (US)

(72) Inventor: William Robert Parkinson, Santa Monica, CA (US)

(21) Appl. No.: 14/323,877

(22) Filed: Jul. 3, 2014

(51) Int. Cl. G06Q 30/02; G06F 17/30

(52) U.S. Cl. CPC G06Q 30/0279; G06F 17/3087; G06Q 50/01

(57) ABSTRACT

Disclosed is a charitable donation interface and related systems and methods. The disclosed systems, methods, and interfaces allow a user to search and/or browse through one or more databases containing a plurality of charitable organizations, causes, and events. Charitable organization home pages allow charitable organizations to interact with users and provide information, and events allow individuals or organizations to create fund-raising campaigns to increase participation. User accounts are used to track user participation, provide rewards, and simplify the user donation process.

### TECHNICAL FIELD

The present disclosure relates generally to charitable giving, and more particularly to systems and methods for giving and receiving charitable donations.

### SUMMARY OF THE INVENTION

The present disclosure may be embodied in a method comprising receiving a search command from a user comprising one or more search criteria; running a search on a database based on the search command received, the database comprising charitable organization data for a plurality of charitable organizations; presenting one or more charitable organizations based on the search run on the database; receiving a selection of one of the one or more charitable organizations presented; receiving a donation payment for the selected charitable organization; and processing the donation payment using a non-profit payment processor.

In a particular aspect, the database may comprise charitable organization data for a plurality of charitable organizations recognized by the federal government as eligible to receive tax-deductible contributions. In a further aspect, the database may comprise charitable organization data for substantially all charitable organizations recognized by the federal government as eligible to receive tax-deductible contributions. The database may comprise the GuideStar® database.

In another aspect, the non-profit payment processor may be recognized by the federal government as eligible to receive tax-deductible contributions. The non-profit payment processor may be the non-profit payment processor provided by Network for Good®.

In a further embodiment, the method may further comprise saving the selected charitable organization as a favorite charity. The method may also comprise sharing information on the donation payment on a social media network. In yet another embodiment, the method may further comprise providing a reward based on donation data for a user.

In another embodiment, the present disclosure may also be embodied in a charitable donation method comprising presenting a user with a plurality of causes; receiving a selection of a cause from the plurality of causes; presenting one or more charitable organizations that are affiliated with the selected cause; receiving a selection of one of the one or more charitable organizations presented; receiving a donation payment for the selected charitable organization; and processing the donation payment using a non-profit payment processor.

In yet another embodiment, the present disclosure may also be embodied in a charitable donation method comprising receiving an event search request; presenting one or more events based on the event search request, each event being affiliated with one or more charitable organizations; receiving a selection of one of the one or more events presented; receiving a donation payment for the selected event; and processing the donation payment using a non-profit payment processor.

In a particular aspect of this embodiment, the selected event may comprise donation matching, a fund-raising competition, and/or a fund-raising drive. In another aspect of this embodiment, the event search request may comprise an event identifier code and/or a geographic limitation.

The present disclosure may also be embodied in computer readable media comprising an instruction set configured to command a computing device to carry out the methods described herein.

### BRIEF DESCRIPTION OF THE DRAWINGS

The drawings are provided for purposes of illustration only and merely depict typical or example implementations. These drawings are provided to facilitate the reader's understanding and shall not be considered limiting of the breadth, scope, or applicability of the disclosure. For clarity and ease of illustration, these drawings are not necessarily to scale.

FIG. 1 is an exemplary home screen of a charitable giving interface in accordance with an embodiment of the present disclosure.

FIG. 2 is an exemplary menu screen of a charitable giving interface in accordance with an embodiment of the present disclosure.

FIG. 3 is an exemplary search screen of a charitable giving interface in accordance with an embodiment of the present disclosure.

FIG. 4 is an exemplary events screen of a charitable giving interface in accordance with an embodiment of the present disclosure.

FIG. 5 is an exemplary charity information page in accordance with an aspect of an embodiment of the present disclosure.

FIG. 6 is an exemplary charity campaigns page in accordance with an aspect of an embodiment of the present disclosure.

FIG. 7 is an exemplary charity links page in accordance with an aspect of an embodiment of the present disclosure.

FIG. 8 is an exemplary charity donation value page in accordance with an aspect of an embodiment of the present disclosure.

FIG. 9 is an exemplary payment processing page in accordance with an aspect of an embodiment of the present disclosure.

FIG. 10 illustrates a sample computing module that may be used to implement certain features and embodiments of the present disclosure.

### DETAILED DESCRIPTION

The disclosure provided herein describes systems and methods for giving and receiving charitable donations.

Non-profit charity organizations provide a wide variety of services that in some way benefit the public. These may include providing funding for medical research, serving the underprivileged, providing religious services for the general public, or drawing attention to important social causes. Such non-profit organizations depend largely on donations from the general public to perform these functions. It is generally accepted that such charitable contributions are a desirable outcome, and incentives are provided to the general public to make financial contributions to charitable organizations. Financial incentives for giving charitable donations to such non-profit organizations (NPOs) are provided by the federal government via tax deductions for charitable donations.

Despite their status as non-profit organizations (NPOs), NPOs are a growing business with more NPOs being registered every year. While this provides greater opportunity for charitable giving, it also creates a potentially overwhelming and confusing environment for the general public. Some people, wishing to donate to a charitable organization, may be overwhelmed by the sheer number of NPOs and be unsure as to which charitable organization would be appropriate. Meanwhile, others may wish to donate to a particular cause but may not be sure where to find information on NPOs that are serving that particular cause. As such, it is desirable to provide the general public with an easy to use interface in which they are presented with a plurality of charitable organizations and are able to browse and/or search through the plurality of charitable organizations to find one that meets the potential donor's criteria. It may also be desirable, for the sake of convenience and ease of giving, for users to be given the ability to provide donations to these charitable organizations directly through the browsing and searching interface. It may also be desirable to ensure that donating to a charitable organization through the interface still allows a user to claim the benefits of charitable giving, such as a federal tax deduction.

In addition to services provided to the general public, the interface may also provide services to NPOs by allowing them to reach the donating public, and providing a medium by which NPOs can provide information to the donating public to distinguish the strengths and benefits of a particular NPO over others. The disclosed systems, methods, and features address these issues, as well as providing other related advantages.

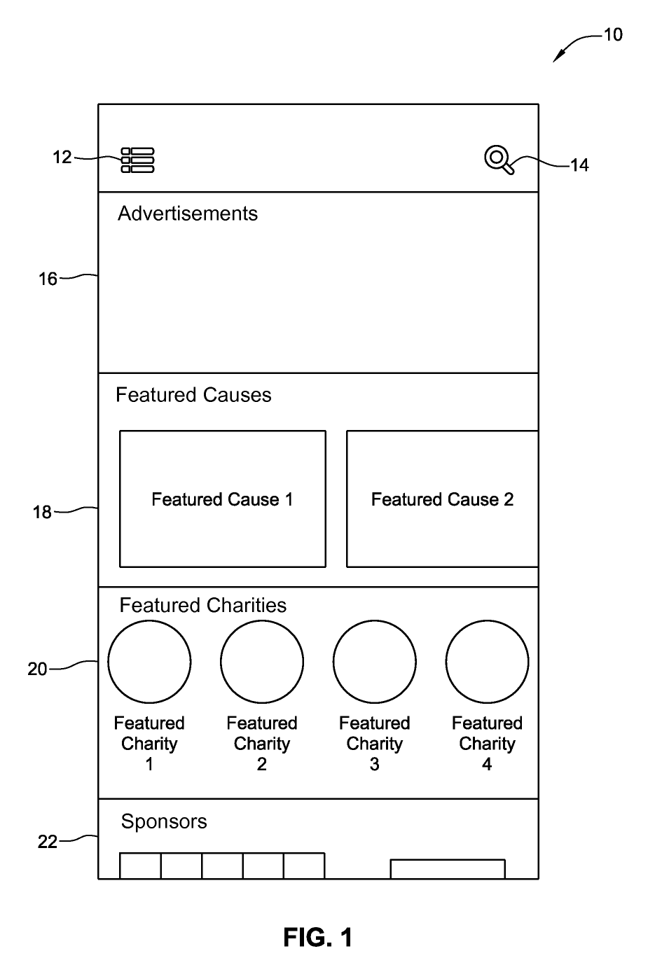

FIG. 1 provides a sample home screen 10 for an exemplary charitable donation interface. The charitable donation interface described herein is depicted as a mobile application to be installed and displayed on a mobile device. As such, it may be referenced as either an “interface” or an “application” or “app” through the present disclosure. However, it should be understood that while the figures present particular exemplary embodiments of the charitable donation interface, changes may be made to the structure, organization, layout, or other features of the interface without departing from the spirit of the present disclosure. The home screen 10 includes a menu button 12 on the upper left hand corner, and a search function button 14 on the upper right hand corner. These functions will be described in greater detail below. The home screen 10 is divided into several regions that provide users with different ways to browse and interact with charitable organizations. In the exemplary home screen 10 shown in FIG. 1, the home screen 10 is divided into four (4) regions. The top region 16 provides advertising space where a number of NPOs may be presented to increase their exposure to the general public. In certain embodiments, advertising space may be sold to NPOs in exchange for greater exposure. Multiple advertisements may be presented in the advertising region 16 with each advertisement being displayed for a certain period of time before being transitioned to the next.

The second region from the top is a featured causes section 18. The featured causes section 18 may present a user with a plurality of “causes” rather than particular NPOs. Causes may include, for example, support for regions recovering from a natural disaster (e.g., relief efforts post-Hurricane Katrina, tsunami relief efforts in Japan, etc.), or research for medical research (e.g., breast cancer research, HIV/AIDS research), and the like. When a user selects a particular cause, the user is presented with a list of NPOs that support the cause. For example, if the user selects Japanese Tsunami relief, the user is presented with a list of all NPOs providing support to relief efforts, such as the American Red Cross, the U.S.-Japan Council, and the Japan Society.

The third region provides a featured charities section 20. This section presents users with a plurality of charitable organizations based on certain criteria. For example, charities may pay a fee to show up in the featured charities section 20. Alternatively, particular charities may be featured based on user-specific characteristics. For example, based on a particular user's charity-viewing history or donation history, the featured charities section may present charities that are similar to other charities viewed by the user or to which the user has previously donated. Or the charities presented to the user may be based on the user's location (e.g., charities located nearby) or other user-specific characteristics (e.g., charities with a particular political affiliation, or charities for particular religious organizations, etc.)

The final region provides advertising space for sponsors 22. The sponsors listed may be sponsors of the charitable donation interface or sponsors for particular charities. While the home screen 10 shown in FIG. 1 includes four vertically-arranged regions for advertisements, featured causes, featured charities, and sponsors, numerous other layouts and features may be incorporated. For example, a user's home screen may be customized according to the user's personal preferences, and may include links to Favorite Causes or Favorite Charities rather than “Featured Causes or “Featured Charities.” Further, if a user wishes not to view advertisements for Sponsors or Charities, the user may be permitted to turn those features off or replace them with other information.

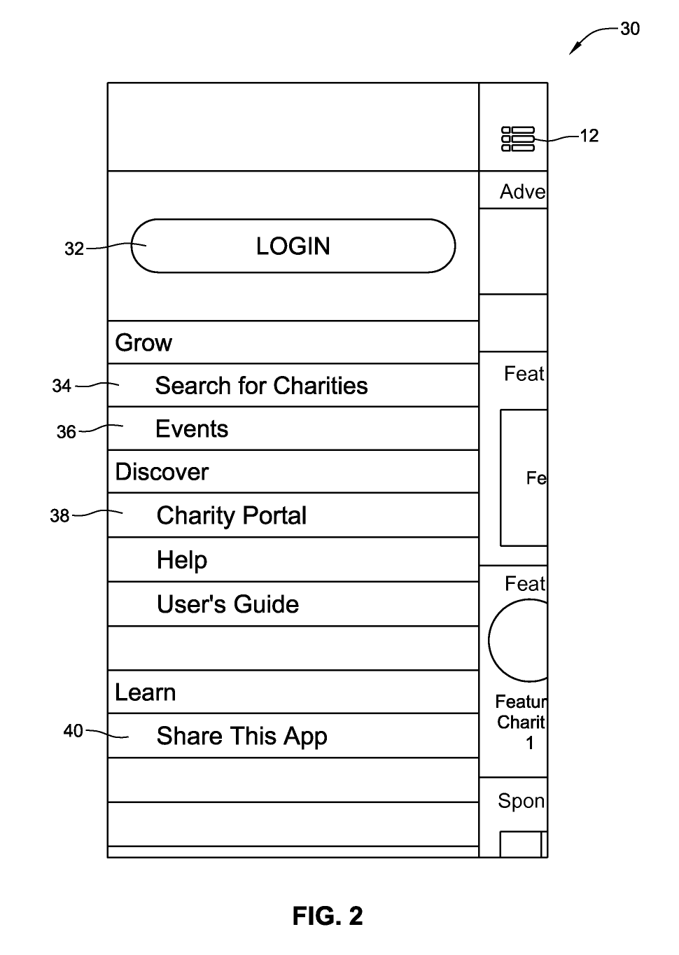

As discussed previously, the top left corner of the home screen 10 in FIG. 1 provides a menu button 12. When the user selects the menu button 12, the user may be presented with a menu screen. FIG. 2 depicts an exemplary embodiment of a menu screen 30 within the charitable donation interface. The menu screen 30 provides a login button 32 which allows a user to log into his or her account. By logging in, the user may be able to customize his or her experience in using the charitable donation interface. As discussed previously, the user may be able to customize the home screen to their liking, and the user may be able to store favorite causes or favorite charities. The user may also be able to store personal information such as payment information to make donations easier.

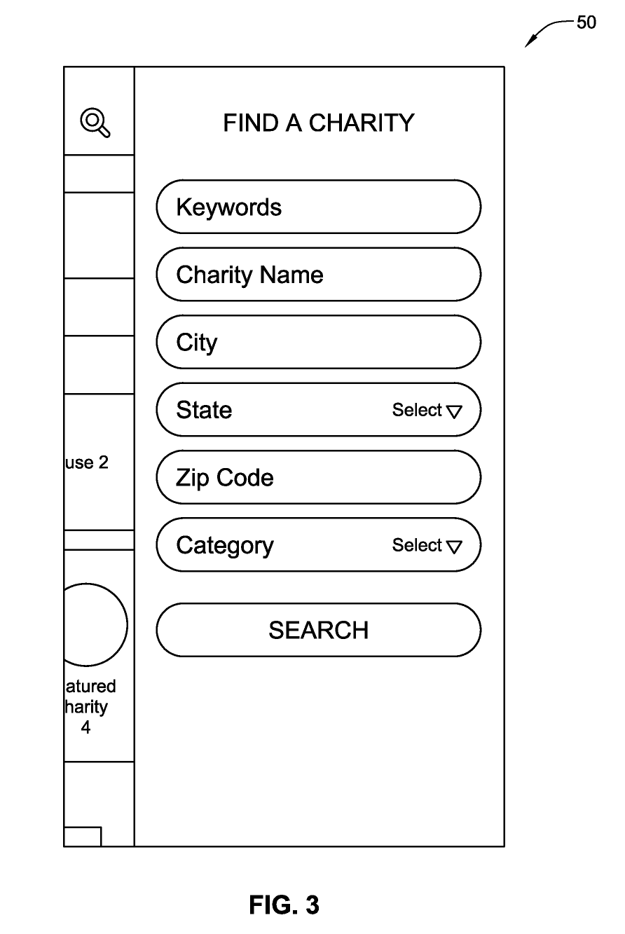

The menu screen 30 also provides a search function 34, which leads users to the search screen 50 shown in FIG. 3. The search button 14 shown on the home screen 10 in FIG. 1 also leads users to the search screen 50. Within the search screen, users are able to search for charities. As can be seen in FIG. 3, users may use the search screen 50 to search for charities by Keyword, Charity Name, City, State, Zip Code, or Category. The search may be run against a database of a plurality of charitable organizations. The app provider may privately maintain the database of charitable organizations, or the database may be a third party database that is accessed the charitable donation interface. In a more particular embodiment, a charitable organization may be required to meet certain criteria in order to be included in the database (e.g., registering to be included in the database or paying a registration fee to the app provider). However, in order to provide users with the broadest range of charitable organization possible, it may be preferable that charitable organizations do not need to be registered with the app provider or a particular database, and the database would simply comprise all charitable non-profit organizations that are recognized by the IRS. An example of a third party database is GuideStar®, which maintains a database of all IRS-recognized nonprofit organizations.

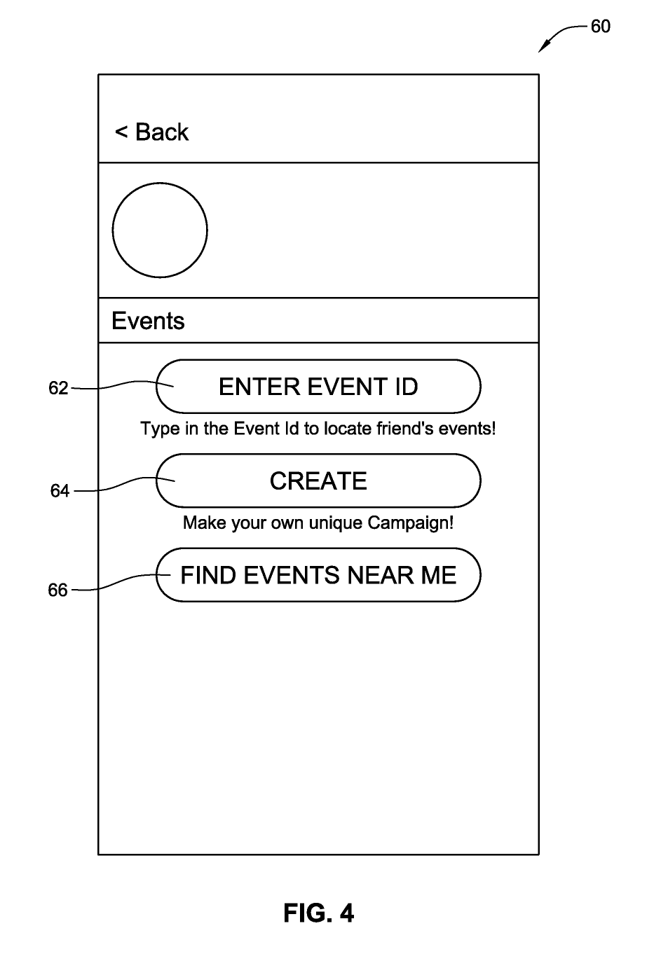

Rather than searching for charities, users may also be able to user the search screen 50 to search for particular causes or events (discussed in greater detail below with reference to FIG. 4). Further, the user may avoid filling in the “City, State, Zip Code” fields by performing a search on a GPS-enabled device and searching for charities, causes, or events near the user's current location, or, alternatively, by storing the user's residential information to perform a search for charities, causes, or events near the user's stored address information.

Referring once again to FIG. 2, the menu screen 30 includes an Events function 36. By selecting the Events function 36, a user is directed to an events screen 60, which is depicted in FIG. 4. Events may encompass a broad range of charitable donation devices that may be created by charities, members of the general public, or other organizations. Examples might include charity drives that create a fundraising goal for a particular charity or cause. These charity drives may be created so as to increase user donations for a particular period or particular goal. Events may also include matching programs where certain sponsors (such as employers, organizations, corporations, or individuals) agree to match contributions made by the general public over a certain period of time and/or up to a certain dollar value. Events may also include competitions between organizations or individuals to see who can raise more funds for a particular cause or charity within a certain period of time. It should be clear that “Events” may comprise a vast range of charity devices that may be used in order to increase the public's awareness of certain charities or causes, or encourages greater donations. Common examples of “Events” include employer matching programs, fund-raising drives, fund-raising competitions, etc. A rewards aspect may also be incorporated into events to encourage further giving by offering rewards. For example, individuals or groups that give a particular amount during a pledge drive might receive a reward commensurate with their level of giving, or individuals or groups who win fund-raising competitions may be awarded prizes. Further, the rewards aspect need not be limited to events. The app/interface provider may provide rewards for frequent use of the interface to give charitable donations, or individual charities may provide rewards for frequent donors. These rewards may be administered through the charitable donation interface disclosed herein.

The events screen 60 shown in FIG. 4 gives users the option of entering an event ID 62, creating an event 64, or finding events nearby 66. Entering an event ID via function 62 allows a user to find a specific event. For example, an employer who has created a donation matching program may register the event, receive an event ID, and then inform their employees that any donations made using the event ID would be matched by the employer. An employee could then open the interface, enter the events screen 60, select the event ID function 62, and input the specified event ID to make a charitable contribution that will be registered as a donation made through the particular event. In this way, event creators can keep track of event-specific information such as donation totals, individuals who donated to the particular event, etc. The “Find Events Near me” function 66 may use a user's GPS coordinates (provided, for example, by a user's mobile device) or user-inputted information to find events in the user's area. Alternatively, a user may be able to use the search screen 50 of FIG. 3 to search for events meeting particular criteria.

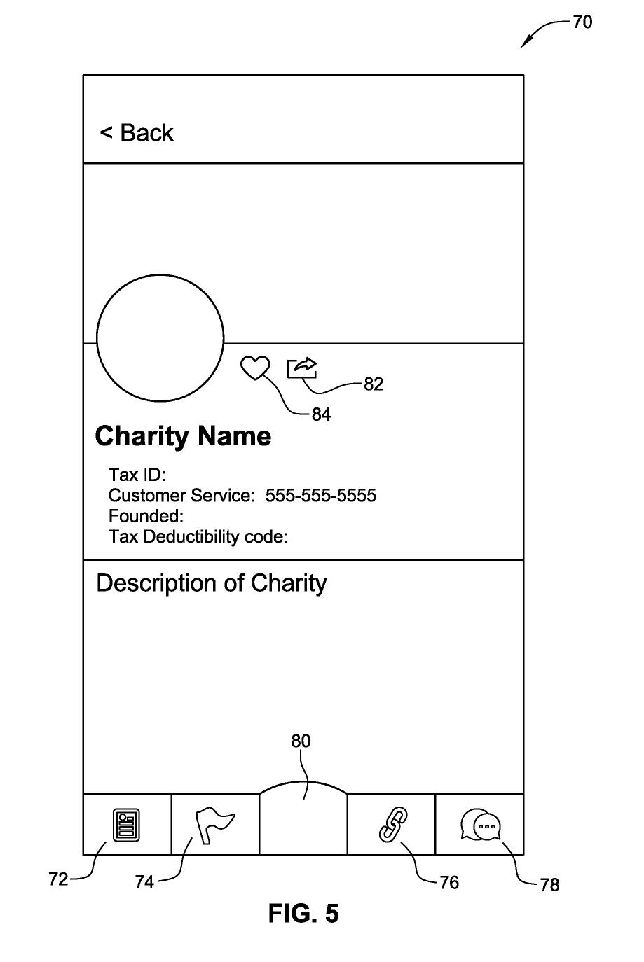

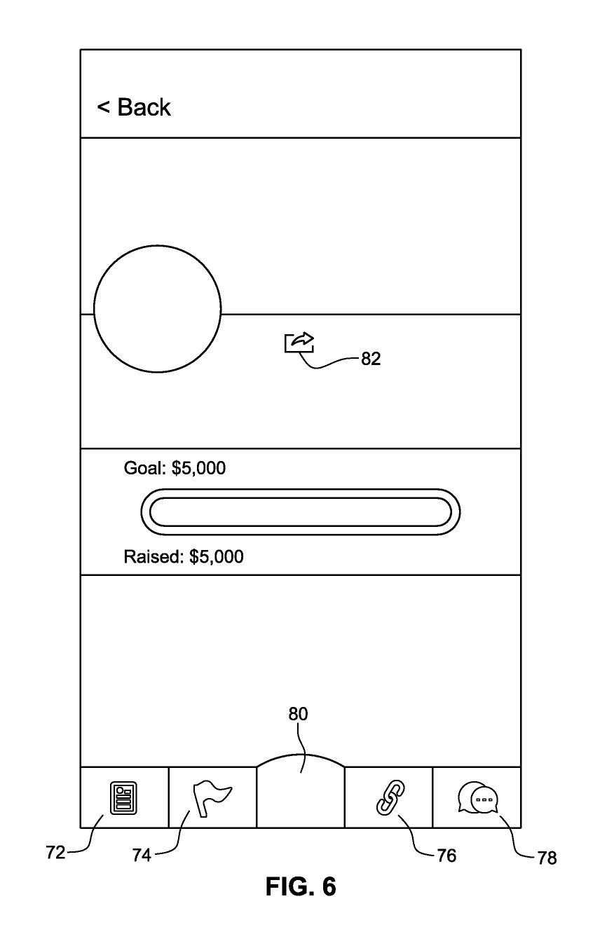

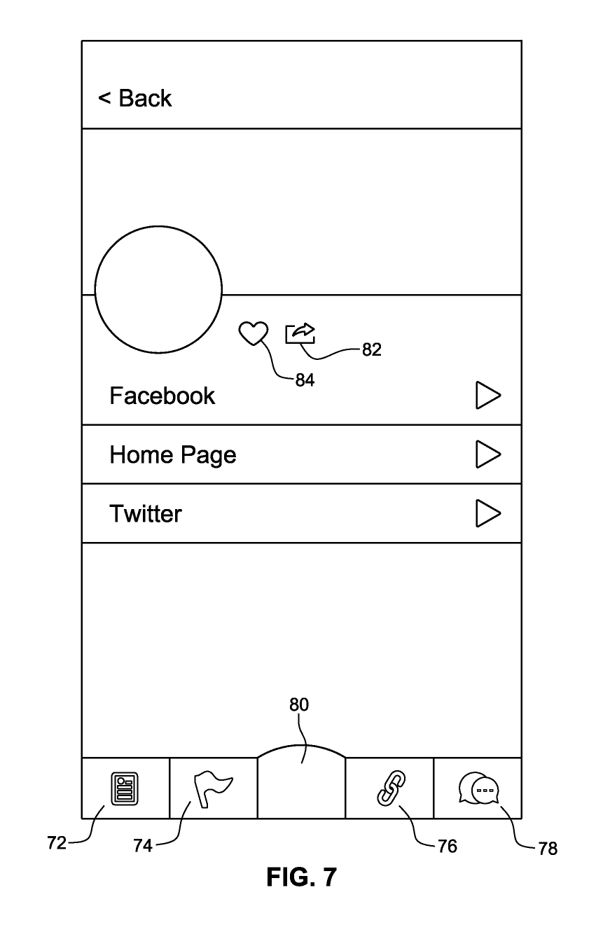

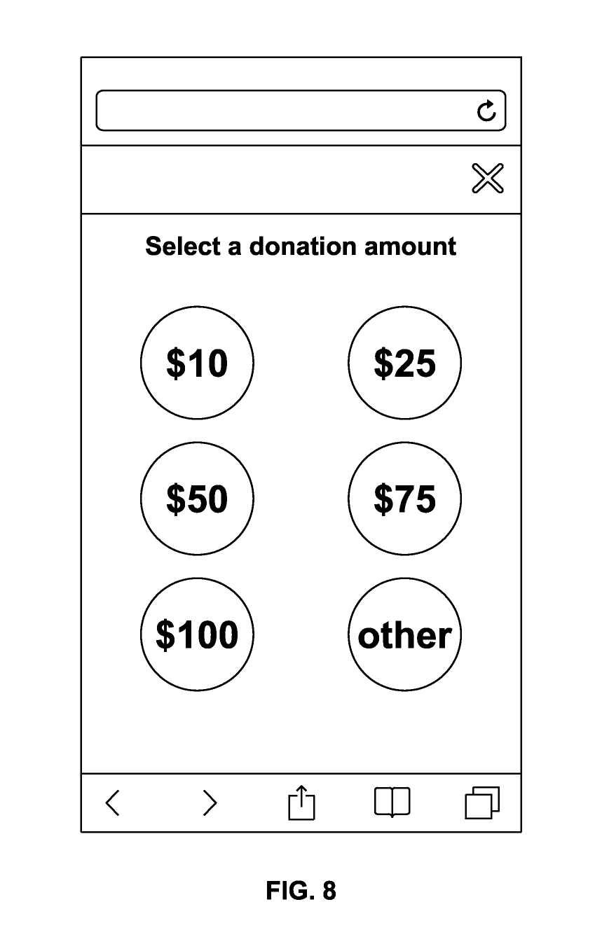

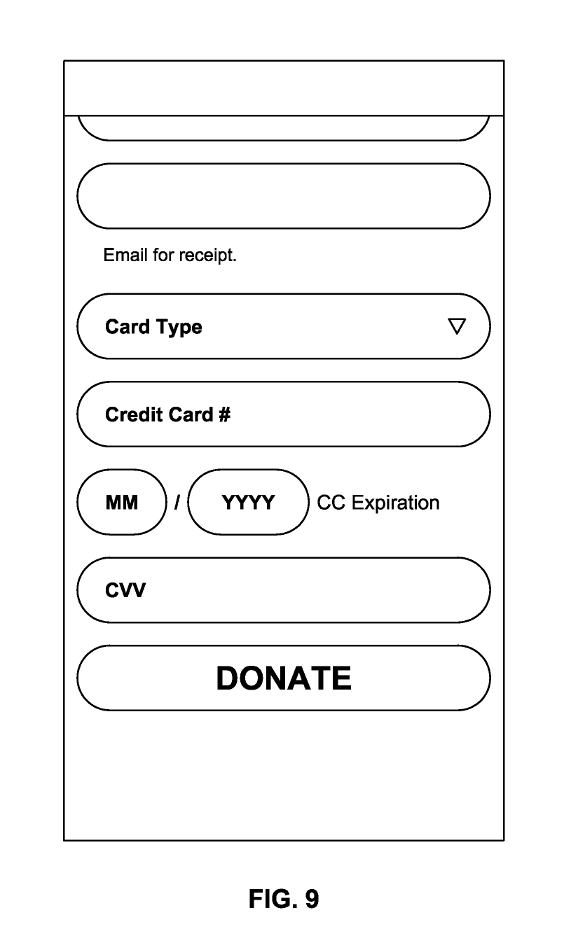

FIG. 5 provides an exemplary charity page 70, which provides users with information relating to a particular charity and allows users to donate to that charity. The charity page 70 includes basic information regarding the charity, such as the Tax ID, customer service phone number, the year the charity was founded, the charity's tax deductibility code, and a description of the charity. The charity page 70 also includes buttons to access the charity page 72, the charity's campaigns 74, charity links 76, charity discussion 78, and a charity donation button 80. Selecting the charity campaign button 74 allows a user to view all campaigns and/or events relating to that charity, as shown in FIG. 6. Selecting the charity link button 76 takes you to a page providing hyperlinks relevant to that charity. An exemplary links page is shown in FIG. 7, which provides links to the charity's Facebook page, Web Home Page, and Twitter page. The charity discussion button 78 allows members of the general public to post comments to the charity's page to make suggestions, ask questions, and/or provide comments. Finally, the donation button 80 allows a user to make a donation to that charity. Selecting the donation button 80 takes a user to the charity amount page shown in FIG. 8. Once a user selects an amount for the charitable donation, the user can enter payment information on the payment screen in FIG. 9.

Payments may be processed by any payment processor. However, in a particular embodiment of the present disclosure, payments are processed by an IRS-recognized non-profit payment processor. This particular embodiment provides the advantage of making the donation a tax-deductible charitable donation. An example of an IRS-recognized non-profit payment processor is Network for Good®.

For basic charity pages, information may automatically be filled in based on information that is readily accessible to be automatically filled in. Such readily accessible information may include a charity's name, tax ID, tax deductibility code, and any other available information available through the GuideStar® database. Further, a charity's campaign page (FIG. 6) may automatically be filled in with links to events that have identified that particular charity as the recipient. However, in addition to and/or in place of the automatic information discussed above, the app provider or charity may fill in additional information in the charity home page 70. For example, an app provider may find it beneficial to provide as much information for each charity as possible, even at the expense of additional manual effort, so as to give users the best experience possible when donating through the interface/application. Similarly, charities may desire to keep their individual pages as complete and updated as possible so as to give users up-to-date information and greater incentive to donate to their charity. In particular embodiments, charities may pay fees to the app provider to unlock certain features of their charity page (e.g., campaigns, links, message board, reward systems, access to donor information, etc.)

Users may share charity information using the share function 82, or share the application with others using the “share this app” feature 40 (FIG. 2). In a further aspect, additional social media interaction may be incorporated into the interface. For example, events and event updates/results may be shared on social media, or users' social media accounts may be synced to share donations made by the user via the application.

Where components or modules of the disclosed interface are implemented in whole or in part using software, in one embodiment, these software elements can be implemented to operate with a computing or processing module capable of carrying out the functionality described with respect thereto. After reading this description, it will become apparent to a person skilled in the relevant art how to implement the disclosure using other computing modules or architectures.

As used herein, the term module might describe a given unit of functionality that can be performed in accordance with one or more implementations. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

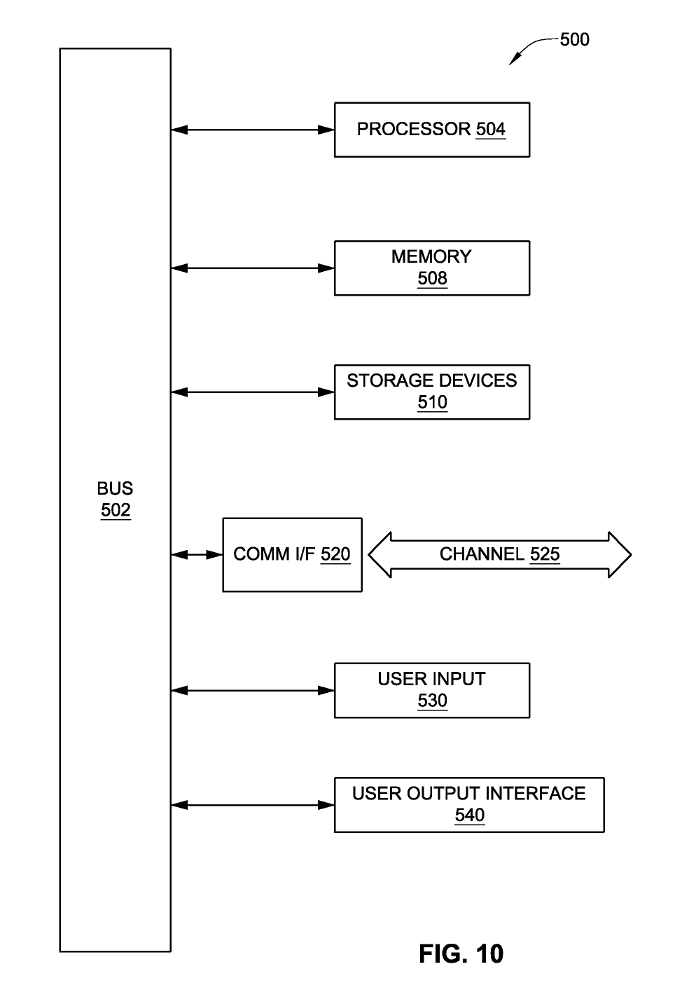

Referring now to FIG. 10, computing module 500 may represent, for example, computing or processing capabilities found within desktop, laptop and notebook computers; hand-held computing devices (PDA's, smart phones, cell phones, palmtops, tablets, etc.); or any other type of special-purpose or general-purpose computing devices as may be appropriate. Computing module 500 might also represent computing capabilities embedded within or otherwise available to a given device. For example, a computing module might be found in other electronic devices such as, for example, televisions, home theaters, Blu-Ray disc players, DVD players, in-car entertainment systems, video game consoles, video download or streaming devices, portable DVD players and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally.

Computing module 500 might also include one or more memory modules, simply referred to herein as main memory 508. Memory may include any non-transitory storage medium. For example, preferably random access memory (RAM) or other dynamic memory, might be used for storing information and instructions to be executed by processor 504. Main memory 508 might also be used for storing temporary variables or other intermediate information during execution of instructions to be executed by processor 504. Computing module 500 might likewise include a read only memory (“ROM”) or other static storage device coupled to bus 502 for storing static information and instructions for processor 504. The computing module 500 might also include one or more various forms of information storage mechanism 510, which might include, for example, a magnetic tape drive, an optical disc drive, a solid state drive, or any other non-volatile memory.

Computing module 500 might also include a communications interface 520. Communications interface 520 might be used to allow software and data to be transferred between computing module 500 and external devices. Examples of communications interface 520 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 520 might typically be carried on signals, which can be electronic, electromagnetic (which includes optical) or other signals capable of being exchanged by a given communications interface 520. These signals might be provided to communications interface 520 via a channel 525. This channel 525 might carry signals and might be implemented using a wired or wireless communication medium. Some examples of a channel might include a phone line, a cellular link, an RF link, an optical link, a network interface, a local or wide area network, and other wired or wireless communications channels.

Computing module 500 might also include one or more user inputs 530. The user input allows for the user to enter commands to the computing module 500 and interact with it. Examples of user inputs might include a computer mouse, a keyboard, a touch-sensitive screen, a stylus, a mousepad, a joystick, an accelerometer, a gyroscope, a camera, a remote control, or any other user input mechanism. These user inputs may be used to interact with the disclosed interface.

The computer module 500 might also include one or more user output interfaces 540. The user output interfaces 540 might be used to interact with the user by presenting information or sensory outputs for the user. Examples of user output interfaces might include visual outputs, such as a display screen or monitor, or audio outputs, such as a speaker or headphone output.

In this document, the terms “computer readable medium” and “computer usable medium” are used to generally refer to media such as, for example, memory 508, storage unit 510, and channel 525. These and other various forms of computer readable media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present disclosure as discussed herein.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features. Additionally, with regard to flow diagrams, operational descriptions and method claims, the order in which the steps are presented herein shall not mandate that various embodiments be implemented to perform the recited functionality in the same order unless the context dictates otherwise. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

Although the disclosure has been presented with reference only to the presently preferred embodiments, those of ordinary skill in the art will appreciate that various modifications can be made without departing from this disclosure.

1. A charitable donation method comprising:
receiving a search command from a user comprising one or more search criteria;
running a search on a database based on the search command received, the database comprising charitable organization data for a plurality of charitable organizations;
presenting one or more charitable organizations based on the search run on the database;
receiving a selection of one of the one or more charitable organizations presented;
receiving a donation payment for the selected charitable organization; and
processing the donation payment using a non-profit payment processor.

2. The method of claim 1, wherein the database comprises charitable organization data for a plurality of charitable organizations recognized by the federal government as eligible to receive tax-deductible contributions.

3. The method of claim 1, wherein the non-profit payment processor is recognized by the federal government as eligible to receive tax-deductible contributions.

4. The method of claim 1, further comprising saving the selected charitable organization as a favorite charity.

5. The method of claim 1, further comprising sharing information on the donation payment on a social media network.

6. The method of claim 1, further comprising providing a reward based on donation data for the user.

7. A charitable donation method comprising:
presenting a user with a plurality of causes;
receiving a selection of a cause from the plurality of causes;
presenting one or more charitable organizations that are affiliated with the selected cause;
receiving a selection of one of the one or more charitable organizations presented;
receiving a donation payment for the selected charitable organization; and
processing the donation payment using a non-profit payment processor.

8. A charitable donation method comprising:
receiving an event search request;
presenting one or more events based on the event search request, each event being affiliated with one or more charitable organizations;
receiving a selection of one of the one or more events presented;
receiving a donation payment for the selected event; and
processing the donation payment using a non-profit payment processor.

9. The method of claim 8, wherein the selected event comprises donation matching.

10. The method of claim 8, wherein the selected event comprises a fund-raising competition.

11. The method of claim 8, wherein the selected event comprises a fund-raising drive.

12. The method of claim 8, wherein the event search request comprises an event identifier code.

13. The method of claim 8, wherein the event search request comprises a geographic limitation.

14. A non-transitory computer-readable medium comprising an instruction set configured to cause a computing device to perform:
receiving a search command from a user comprising one or more search criteria;
running a search on a database based on the search command received, the database comprising charitable organization data for a plurality of charitable organizations;
presenting one or more charitable organizations based on the search run on the database;
receiving a selection of one of the one or more charitable organizations presented;
receiving a donation payment for the selected charitable organization; and
processing the donation payment using a non-profit payment processor.

15. A non-transitory computer readable medium comprising an instruction set configured to cause a computing device to perform:
presenting a user with a plurality of causes;
receiving a selection of a cause from the plurality of causes;
presenting one or more charitable organizations that are affiliated with the selected cause;
receiving a selection of one of the one or more charitable organizations presented;
receiving a donation payment for the selected charitable organization; and
processing the donation payment using a non-profit payment processor.

16. A non-transitory computer readable medium comprising an instruction set configured to cause a computing device to perform:
receiving an event search request;
presenting one or more events based on the event search request, each event being affiliated with one or more charitable organizations;
receiving a selection of one of the one or more events presented;
receiving a donation payment for the selected event; and
processing the donation payment using a non-profit payment processor.

17. The non-transitory computer-readable medium of claim 16, wherein the selected event comprises donation matching.

18. The non-transitory computer-readable medium of claim 16, wherein the selected event comprises a fund-raising competition.

19. The non-transitory computer-readable medium of claim 16, wherein the selected event comprises a fund-raising drive.

20. The non-transitory computer-readable medium of claim 16, wherein the event search request comprises an event identifier code.

21. The non-transitory computer-readable medium of claim 16, wherein the event search request comprises a geographic limitation.
